(19) United States
(12) Patent Application Publication
(10) Pub. No.: US 2002/0054039 A1
(43) Pub. Date: May 9, 2002

(54) 2.5 dimensional head modeling method

(75) Inventors: Young-Wei Lei, Taipei (TW); Ming Ouhyoung, Taipei (TW)

Correspondence Address: DARBY & DARBY P.C., 805 Third Avenue, New York, NY, 10022, US

(73) Assignee: CyberLink Corp.

(21) Appl. No.: 09/907,042

(22) Filed: Jul. 17, 2001

(30) Foreign Application Priority Data
Nov. 9, 2000 (TW) 89123719

(51) Int. Cl. G06T 15/00; G06T 15/30; G06T 17/20; G06K 9/36; G09G 5/00

(52) U.S. Cl. 345/419; 345/423; 345/582; 382/285

(57) ABSTRACT

The present invention discloses an image modeling method, comprising the steps of: providing image data comprising at least a head, wherein the image data of the head is comprised of a skull area; obtaining a first retrieved image data of the image data in the projected area of the skull; obtaining a second retrieved image data of the image data other than the first retrieved image data and a background image; processing the first retrieved image data in a three dimensional image processing technique, which produces three dimensional image data; processing the second retrieved image data to become a two dimensional planar image data set; and displaying the three dimensional image data in the projected area of the skull of the two dimensional planar image data, and combining the three dimensional image data and the two dimensional planar image data to become combined two and three dimensional image data.

### BACKGROUND OF THE INVENTION

1. Field of the Invention

The present invention relates to an image modeling method, and more particularly to an image modeling method which displays an image of a head in 3D mode and displays the rest of the subject's image in 2D mode.

2. Description of the Prior Art

In recent years, model-based image coding has been widely applied in many fields. Among these, visual communication is the most popular application. Examples of such usage are video phones, visual meetings utilizing MPEG-4 compression technologies, and WAP-enabled mobile phones and automatic teller machines. In visual communication, due to the subject being the image of a head (and a portion of the shoulders), the capture of the image is usually performed by focusing on the head to reduce the amount of data transmitted. One possible method is to introduce a 3D head model and a texture mapping technique. An example is the well known CANDIDE head model (Mikael Rydfalk “DANDIDE-a Parameterised Face,” Linkoping University, Report LiTH-ISY-I-0866, October 1987). In FIG. 1, a general system model of a model-based face image coding is illustrated. First, the facial image of the user is inputted to a encoder 10, then a facial model to fit the facial image of the user is adapted. Next, facial features and head motion are analyzed to form an analyzed data set. Subsequently, the analyzed data is transmitted via a transmitting medium 15 to a decoder 20 to synthesize a realistic facial image.

However, the problem with the current three dimensional image modeling technique is that it can not vividly and naturally show a three dimensional image with hair. At the moment, an image with hair shown in the three dimensional model appear to be rough and unnatural to the naked eyes. Since there are many hairstyles and the contours are very different from one to another, it is very difficult for current three dimensional image modeling techniques to define a three dimensional image for the subject's hair. Nevertheless, it is not essential to show the image of the hair in visual phones, visual meetings, WAP-enabled mobile phones or ATMs, which all provide an image for conversation. This lowers the quality of the image.

### SUMMARY OF THE INVENTION

In order to solve the above problem, the object of the present invention is to provide an image modeling method, which processes a facial features image in a three dimensional mode and displays the image of the other parts of the face in two dimensional mode. That is, the hair, the neck and the planar parts of the facial contour are shown in a planar image. By combining the two and three dimensional modes, a facial features image is processed separately, which makes the facial features image three dimensional, and the image elements that cannot be processed in three dimensional mode are processed in two dimensional mode. Thereby, the overall image is natural and facial expressions can be displayed clearly, which in turn makes the interactions between the user and the image livelier and more dynamic.

To achieve the above-mentioned object, the present invention provides an image modeling method, which comprises the following steps: providing image data comprising at least a head, wherein the image data of the head is comprised of a skull area; obtaining a first retrieved image data set of the image data in the projected area of the skull and obtaining a second retrieved image data set of the image data other than the first retrieved image data and a background image; and processing the first retrieved image data using a three dimensional image processing technique, which produces three dimensional image data and processing the second retrieved image data to become two dimensional planar image data; displaying the three dimensional image data in the projected area of the head of the two dimensional planar image data, and combining the three dimensional image data and the two dimensional planar image data to become a combined two and three dimensional image.

### BRIEF DESCRIPTION OF THE DRAWINGS

The present invention will become more fully understood from the detailed description given herein and the accompanying drawings, given by way of illustration only and thus not intended to be limitative of the present invention.

FIG. 1 shows the general model of a facial image of a model-based image coding system.

FIG. 2 shows the operation flowchart of an image modeling method of the present invention.

FIG. 3 shows the sub-operation flowchart of step S4 in FIG. 2.

FIGS. 4A˜4G show the application mentioned in the embodiments of the present invention.

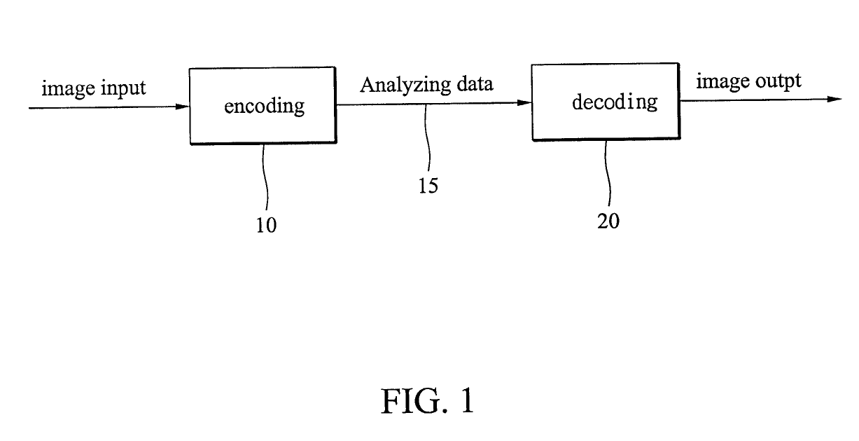

### DETAILED DESCRIPTION OF THE INVENTION

Embodiments

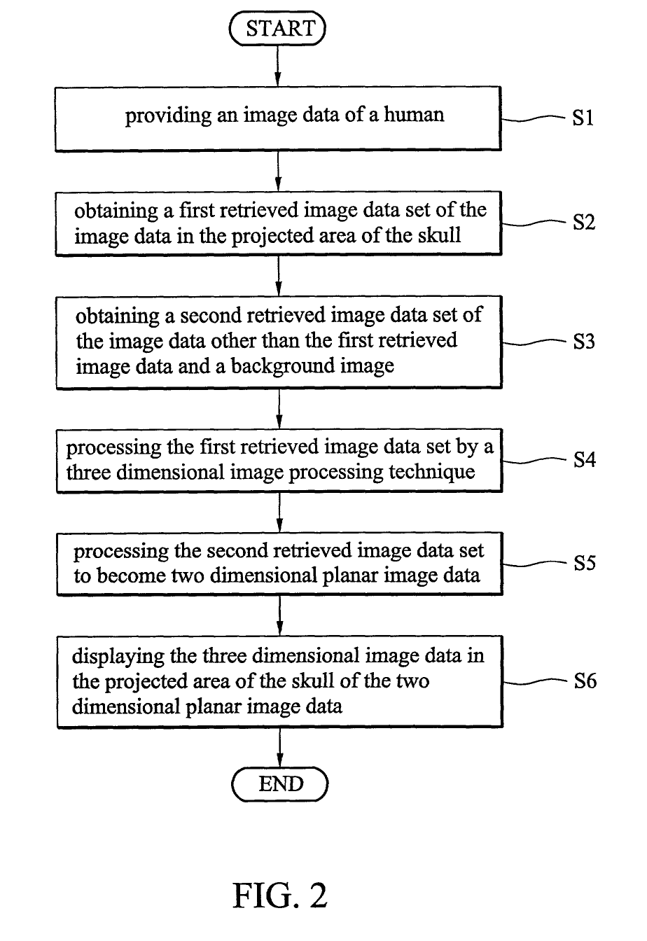

Referring to FIG. 2, which illustrates the operation flow chart of the image modeling method of the present invention.

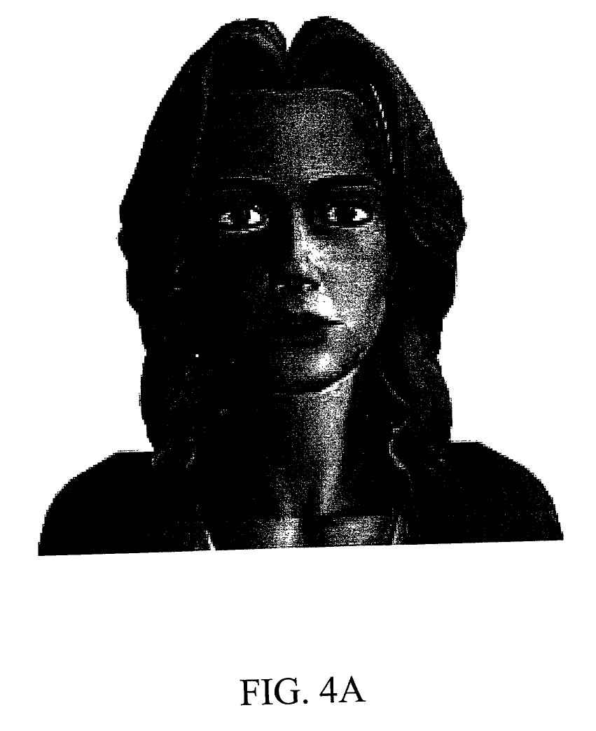

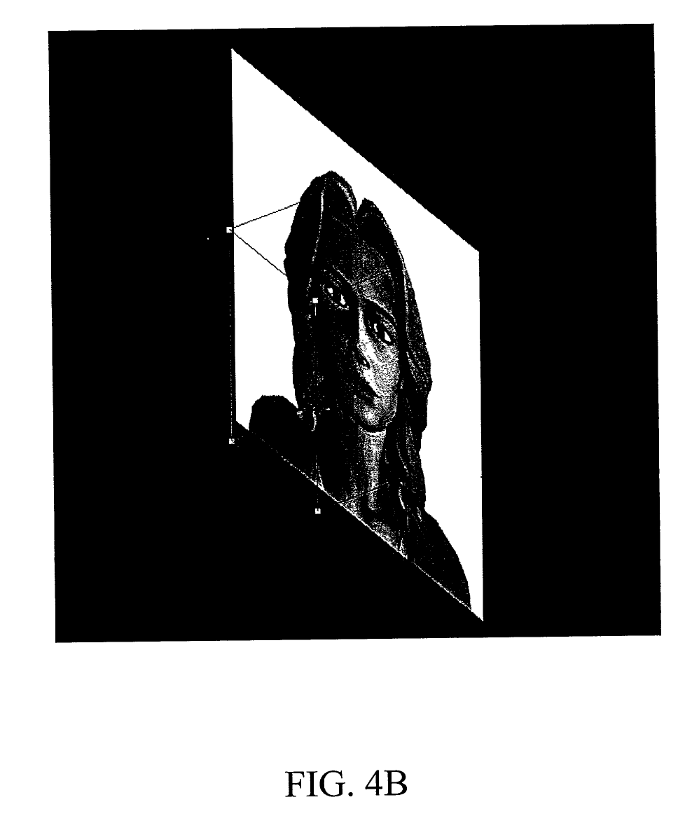

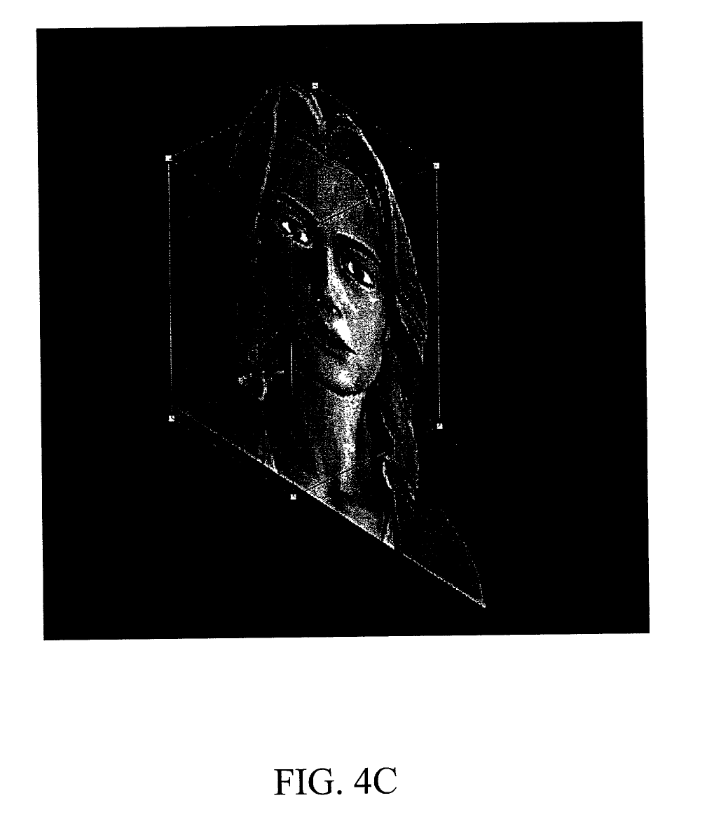

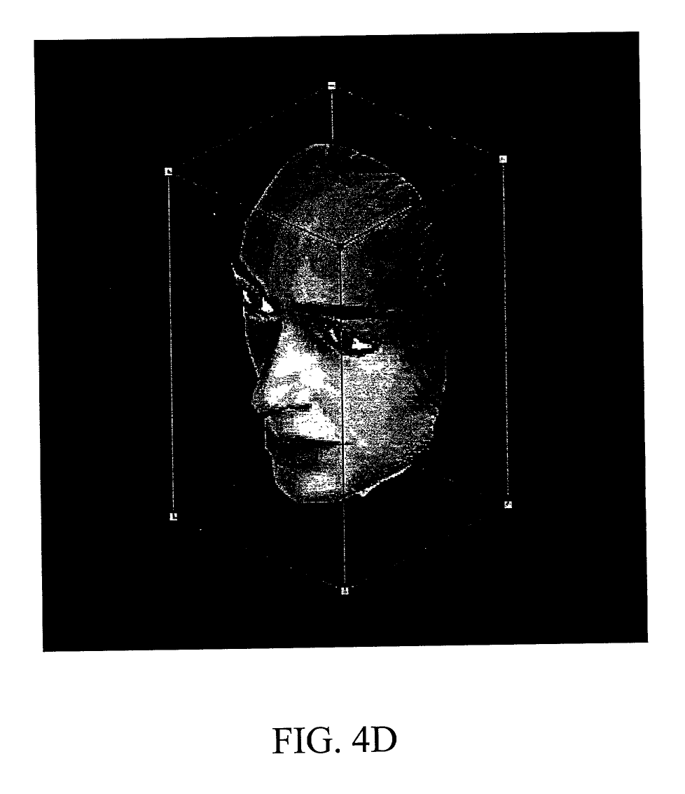

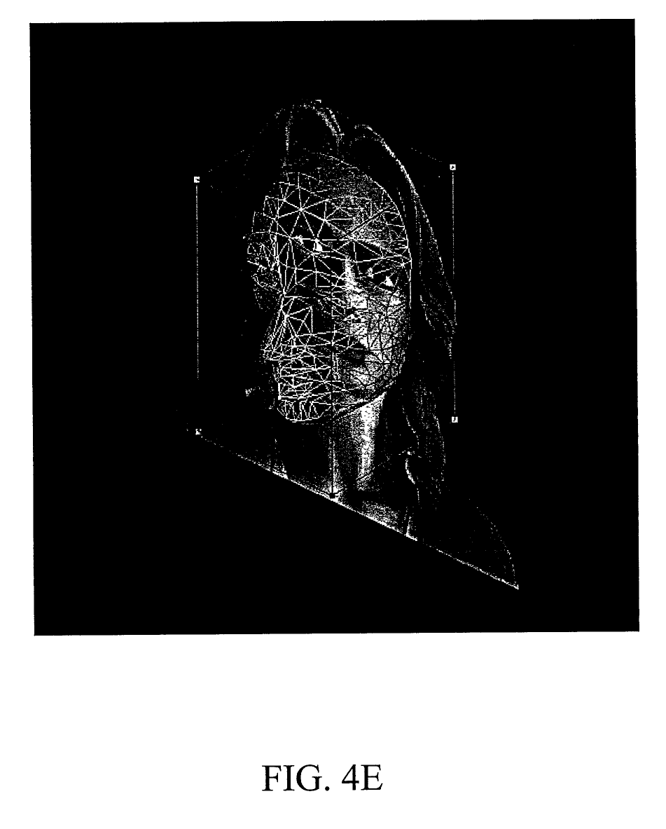

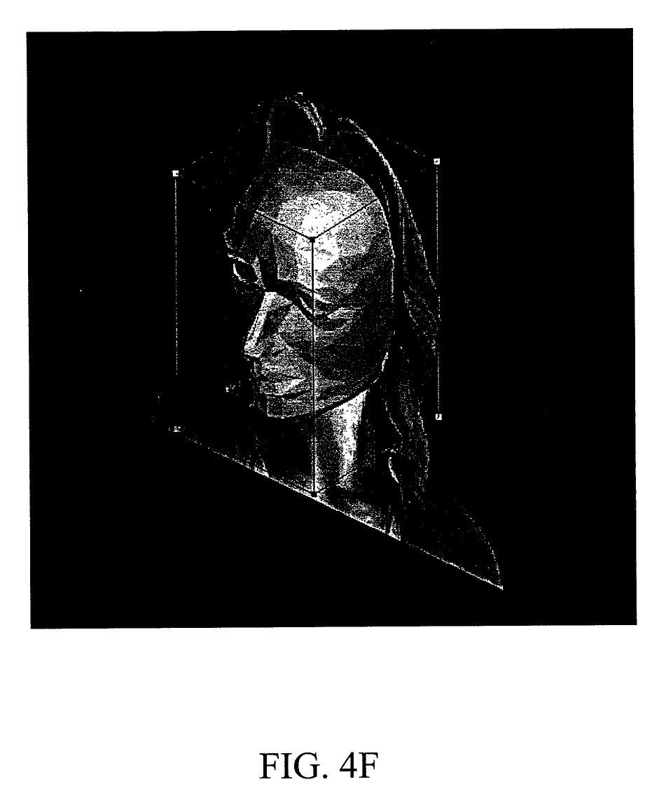

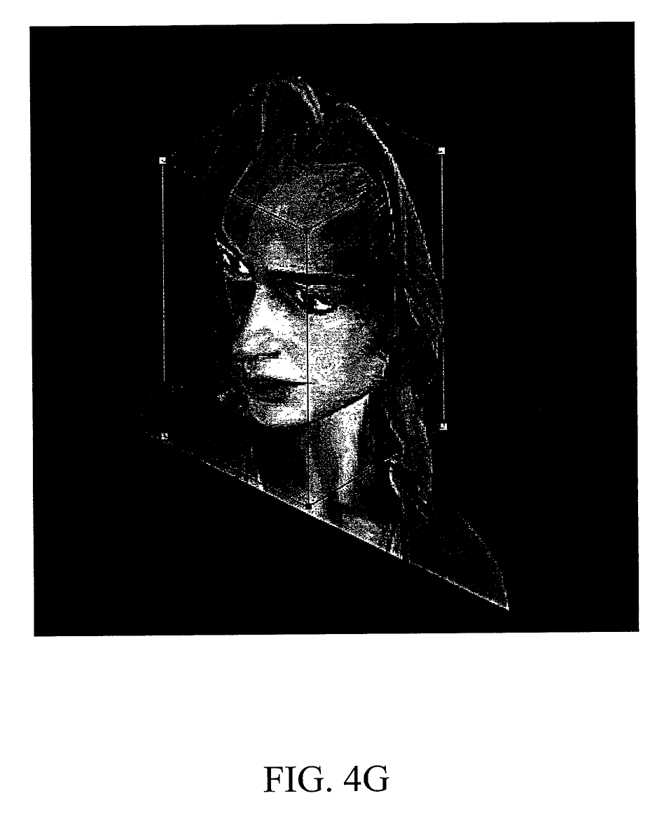

First, image data of a human (S1) is provided (as shown in FIG. 4A). The image data of a human comprises at least an image data set of the head (referring to the labeled area in FIG. 4B). The image data of the head is comprised of a skull area, mainly the front portion.

Thereafter, the image (S2) of the image data of a human in the projected area of the skull is collected (referring to the labeled area in FIG. 4C) to be a first retrieved image data set. The first retrieved image data is comprised of the facial features of the front of a human and the hair covering the forehead and the face. This step is carried out to collect the facial features or the image which is to be processed in three dimensional mode.

Next, the image data of a human other than the first retrieved image data and background image data is collected to be the second retrieved image data set (S3). The second retrieved image data includes the hair, the neck, the body and clothing outside of the projected area of the skull in the image data of a human, e.g. the area not including the background image shown in the unlabelled area in FIG. 4C. This step is carried out to isolate the image of the human from the background image.

It should be noted that the sequence of steps S2 and S3 can be adjusted depending on the actual application, as long as the image of the facial features and the background image of the human to be three dimensionally processed are isolated from the image to be processed in two dimensional mode. The background image is interchangeable depends on the application. Consequently, the image produced can be used with different backgrounds as required.

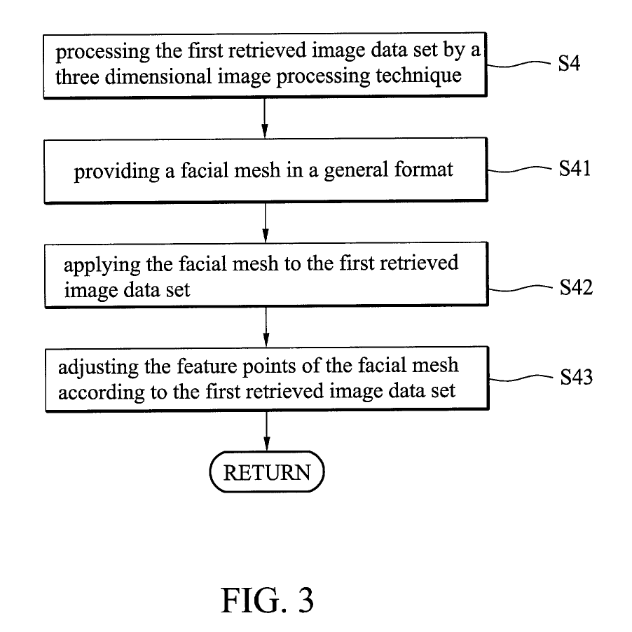

Next, the first retrieved image data (S4) uses the three dimensional process to produce a three dimensional image data set (referring to FIG. 4D). The detailed step 4 is shown in FIG. 3. FIG. 3 shows the sub-operation flowchart of step 4 in FIG. 2.

A facial mesh of the general format (S41) is provided. The facial mesh is made up of a plural mesh and feature points (referring to labeled area in FIG. 4E). The structure of the facial mesh can be designated by the standard of MPEG 4.

Thereafter, the facial mesh is applied to the first retrieved image data (S42) and the two images are overlapped. This tells the user the difference in facial features between the facial image of the first retrieved image data and the facial mesh.

Finally, the feature points on the facial mesh are adjusted according to the first retrieved image data (S43). Consequently, the first retrieved image data is displayed as a three dimensional image data set in a three dimensional mode (referring to FIG. 4F). The above three dimensional image processing is described in detail in CANDIDE facial model (Mikael Rydfalk “DANDIDE-a Parameterised Face,” Linkoping University, Report LiTH-ISY-I-0866, October 1987).

Next, the second retrieved image data is processed to become a two dimensional planar image data (S5). The so-called two dimensional planar image data is image data shown in two dimensional mode and the image data can be displayed in tilt-angle changing format.

Similarly, the sequence of steps S4 and S5 can be adjusted based on actual application, their order is not fixed.

Finally, the three dimensional image data is displayed in the projected area of the skull of the two dimensional planar image data (S6). After filling the three dimensional image data processed in S4 in the projected area of the skull of the two dimensional planar image data, the three dimensional image data and the two dimensional planar image data can be combined to become a two dimensional-three dimensional image data simultaneously having a two dimensional mode and a three dimensional mode.

According to the image modeling method of the embodiment of the present invention, certain parts of a facial image are processed in a combined two and three dimensional combined mode. This renders the facial features three dimensional and displays the image data that cannot be processed in three dimensional mode in a two dimensional mode. However, the horizontal shifting angle of the two dimensional-three dimensional combined image data must be confined within 30 degrees so that the effect of the two dimensional planar image displayed will not be affected by a excessive shifting angle. Consequently, the appearance of the overall image is natural and the interaction between the user and the image is much more lively thanks to the clearly displayed facial expression in three dimensional mode.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An image modeling method, comprising:
providing an image data set comprising at least a head, wherein the image data of the head is comprised of a skull area;
obtaining a first retrieved image data set of the image data in the projected area of the skull and obtaining a second retrieved image data of the image data other than the first retrieved image data and a background image; and
processing the first retrieved image data by a three dimensional image processing technique, which produces three dimensional image data, and processing the second retrieved image data set to become two dimensional planar image data.

2. The image modeling method as claimed in claim 1, further comprising:
displaying the three dimensional image data in the projected area of the skull of the two dimensional planar image data, and combining the three dimensional image data and the two dimensional planar image data to become combined two and three dimensional image data.

3. The image modeling method as claimed in claim 2, further comprising the step of:
combining the two and three dimensional image data with certain background image data.

4. The image modeling method as claimed in claim 3, wherein the three dimensional image processing technique comprises the following steps:
providing a facial mesh with mesh and feature points;
placing the facial mesh in the first retrieved image data; and
adjusting the feature points of the facial mesh according to the first retrieved image data, and producing the three dimensional image data.

5. The image modeling method as claimed in claim 4, wherein the first retrieved image data includes the facial features of the front of a human and the hair covering the forehead and the face.

6. The image modeling method as claimed in claim 5, wherein the second retrieved image data includes at least one of the hair, the neck, body and clothing of the image of the human other than the projected area of the skull.

7. An image modeling method, comprising:
providing an image data comprising at least a head, wherein the image data of the head is comprised of a skull area;
obtaining a first retrieved image data of the image data in the projected area of the skull;
obtaining a second retrieved image data of the image data other than the first retrieved image data and a background image;
processing the first retrieved image data by a three dimensional image processing technique, which produces three dimensional image data;
processing the second retrieved image data to become two dimensional planar image data;
displaying the three dimensional image data in the projected area of the skull of the two dimensional planar image data, and combining the three dimensional image data and the two dimensional planar image data to become a two dimensional-three dimensional image data; and
combining the two dimensional-three dimensional image data with a certain background image data.

8. The image modeling method as claimed in claim 7, wherein the three dimensional image processing technique comprises the following steps:
providing a facial mesh with mesh and feature points;
placing the facial mesh in the first retrieved image data; and
adjusting the feature points of the facial mesh according to the first retrieved image data, and producing three dimensional image data.

9. The image modeling method as claimed in claim 5, wherein the first retrieved image data includes the facial features of the front portion of a human and the hair covering the forehead and the face.

10. The image modeling method as claimed in claim 5, wherein the second retrieved image data includes at least one of the hair, the neck, body and clothing of the image of the human other than the projected area of the skull.
